(19) United States
(12) Patent Application Publication
(10) Pub. No.: US 2005/0111819 A1
(43) Pub. Date: May 26, 2005

(54) System and method for allowing time-shifted access to multiple programs at the same time

(76) Inventors: Christopher J. Cormack, Hillsboro, OR (US); Tony Moy, Beaverton, OR (US)

Correspondence Address: Blakely, Sokoloff, Taylor & Zafman LLP;Suite 101, 5285 S.W. Meadows Road, Lake Oswego, OR, 97035, US

(21) Appl. No.: 10/723,008

(22) Filed: Nov. 26, 2003

(51) Int. Cl. H04N 5/91

(52) U.S. Cl. 386/46

(57) ABSTRACT

A method and system for allowing time-shifted access to multiple programs or channels at the same time. A resource manager receives a request to change to a first channel. As a first personal video recorder (PVR) engine writes a media stream of the first channel to a first circular buffer, a playback engine reads the media stream of the first channel from the first circular buffer and sends the media stream to a display. The playback engine discontinues the reading of the media stream of the first channel once the resource manager receives a request to change to a second channel. Here, the first PVR engine continues to write the media stream of the first channel. A second PVR engine writes a media stream of the second channel to a second circular buffer while the playback engine reads the media stream of the second channel from the second circular buffer and sends the read media stream to the display.

### BACKGROUND

The convergence of the television receiver and the personal computer has accelerated with the advent of the set-top computer systems. These systems, sometimes called set-top boxes, use a conventional analog or digital television receiver as a display for computer systems. In some cases, the set-top box sits on top of the television receiver. By combining the capabilities of a computer system and a television, the system may provide advanced television programming features, such as an electronic programming guide, without requiring the user to incur any unnecessary costs for an additional monitor.

Currently, high definition television (HDTV) systems receive both digital and analog television broadcasts. The digital broadcast may include one of the various formats of HDTV.

The taste of television viewers varies across the gamut of ages and personality types. For example, a particular viewer may be a sports fan that often finds himself or herself switching from one channel to another trying to watch several sport programs at the same time. Unfortunately, television programs tend to go to commercials at the same time. Thus, when the viewer switches from one program or channel to another during commericial breaks, he or she often only sees the commercials and not the other program as desired. The result is that a viewer trying to watch more than one program at the same time ends up missing parts of each of the programs. This can be frustrating to say the least.

One possible option to the above is to watch one program while recording the other program to watch at a different time. This option is not desireable for all viewers. For example, in the instance of a sports program, this option may not maintain the feeling of a live broadcast. Here, the viewer may hear the final score prior to watching the recorded program or may never have the opportunity to watch the recorded program at a future time.

### BRIEF DESCRIPTION OF THE DRAWINGS

The invention may be best understood by referring to the following description and accompanying drawings that are used to illustrate embodiments of the invention. In the drawings:

FIG. 1 illustrates one embodiment of an entertainment system environment in which some embodiments of the present invention may operate;

FIG. 2 illustrates one embodiment of a media center set-top box in which some embodiments of the present invention may operate;

FIG. 3 is a flow diagram of one embodiment of a process for allowing time-shifted access to multiple programs via a media center set-top box;

FIG. 4 is a flow diagram of one embodiment of a process for determining which tuner to assign to a channel's media stream;

FIG. 5 is a flow diagram of one embodiment of a process for using an algorithm to determine which tuner to make available to the channel's media stream;

FIG. 6 is a flow diagram of one embodiment of a process for resetting the available tuner's circular buffer; and

FIG. 7 is a flow diagram of one embodiment of a process for reading from the circular buffer.

### DESCRIPTION OF EMBODIMENTS

A method and system for allowing time-shifted access to multiple programs at the same time are described. In the following description, for purposes of explanation, numerous specific details are set forth. It will be apparent, however, to one skilled in the art that embodiments of the invention can be practiced without these specific details.

Embodiments of the present invention may be implemented in software, firmware, hardware or by any combination of various techniques. For example, in some embodiments, the present invention may be provided as a computer program product or software which may include a machine or computer-readable medium having stored thereon instructions which may be used to program a computer (or other electronic devices) to perform a process according to the present invention. In other embodiments, steps of the present invention might be performed by specific hardware components that contain hardwired logic for performing the steps, or by any combination of programmed computer components and custom hardware components.

Thus, a machine-readable medium may include any mechanism for storing or transmitting information in a form readable by a machine (e.g., a computer). These mechanisms include, but are not limited to, floppy diskettes, optical disks, Compact Disc, Read-Only Memory (CD-ROMs), magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, a transmission over the Internet, electrical, optical, acoustical or other forms of propagated signals (e.g., carrier waves, infrared signals, digital signals, etc.) or the like.

Some portions of the detailed descriptions that follow are presented in terms of algorithms and symbolic representations of operations on data bits within a computer system's registers or memory. These algorithmic descriptions and representations are the means used by those skilled in the data processing arts to convey the substance of their work to others skilled in the art most effectively. An algorithm is here, and generally, conceived to be a self-consistent sequence of operations leading to a desired result. The operations are those requiring physical manipulations of physical quantities. Usually, although not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that discussions utilizing terms such as “processing” or “computing” or “calculating” or “determining” or the like, may refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the following detailed description of the embodiments, reference is made to the accompanying drawings that show, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention. Moreover, it is to be understood that the various embodiments of the invention, although different, are not necessarily mutually exclusive. For example, a particular feature, structure, or characteristic described in one embodiment may be included within other embodiments.

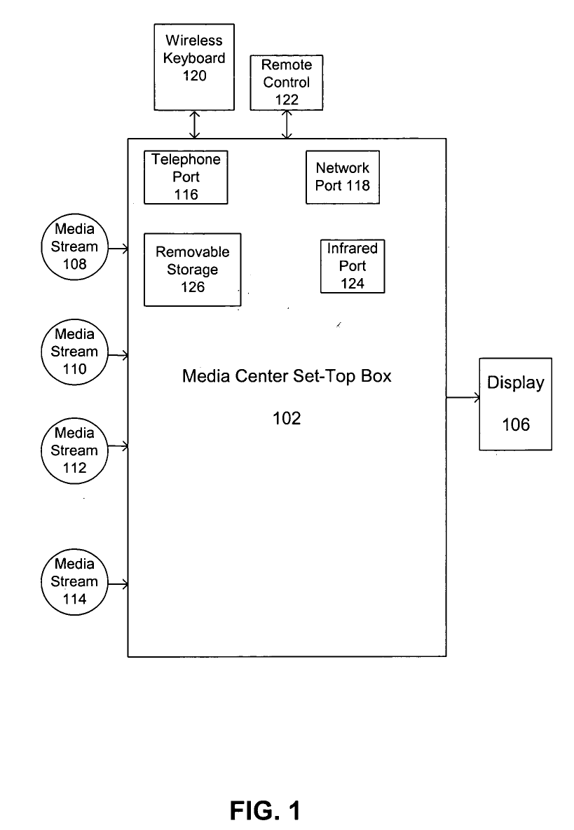

FIG. 1 illustrates one embodiment of an entertainment system environment in which some embodiments of the present invention may operate. FIG. 1 shows an entertainment system with a wide range of installed equipment. This equipment is shown as examples of many of the possibilities. The entertainment system as shown in FIG. 1 may be used in a much simpler or still more complex system. The entertainment center as described in FIG. 1 is able to support communication through WAN and LAN connections, Bluetooth, IEEE 802.11, USB, 1394, IDE, PCI and infrared. Other interfaces may be added or substituted for those described as new interfaces are developed and according to the particular application for the entertainment system. Many of the connections may be removed to reduce cost. The specific devices shown in FIG. 1 represent one example of a configuration that may be suitable for a consumer home entertainment system and is not meant to limit the invention.

Referring to FIG. 1, the entertainment system includes, but is not necessarily limited to, a media center set-top box 102, a display 106, one or more of media streams 108, 110, 112 and 114, a wireless keyboard 120 and a remote control 122. Media center set-top box 102 further includes a telephone port 116, a network port 118, an infrared port 124 and removable storage 126. Each of these components is described in more detail next.

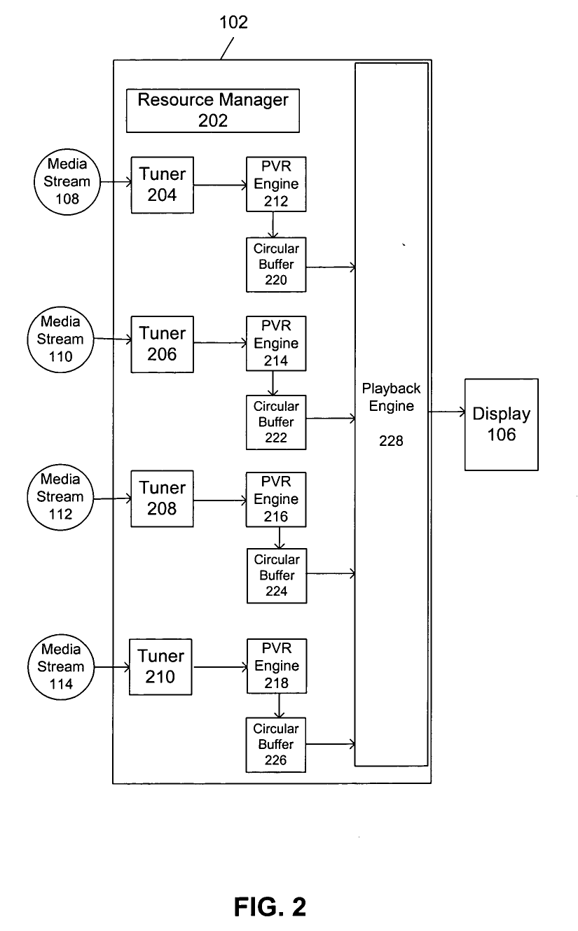

Media center set-top box 102 provides the functionality to allow a user time-shifted access to multiple programs at the same time. The specific components of media center set-top box 102 utilized by embodiments of the invention are described below with reference to FIG. 2.

In one embodiment of the present invention, media center set-top box 102 includes multiple personal video recorder engines (PVR engines). PVR is a generic term for a device that is similar to a video cassette recorder (VCR) but records television data in digital format as opposed to the VCR's analog format. VCRs utilize analog tapes to record and play programs broadcast over television, but PVRs encode video data in MPEG-1 or MPEG-2 formats and store the data in a hard drive. PVRs may encode other types of data and other types of data may be added or substituted for those described as new types of data are developed and according to the particular application for the PVR. PVRs have all of the same functionality of VCRs (recording, playback, fast forwarding, rewinding, pausing, etc.) plus the ability to instantly jump to any part of the program without having to rewind or fast forward the data stream.

A typical PVR is made up of two elements, a device that stores its hardware elements (such as the hard disk drive, power supply and buses) and the software in the form of a subscription service that provides programming information and the ability to encode the data or media streams. A PVR is also referred to as a hard disk recorder (HDR), digital video recorder (DVR), personal video station (PVS), or a personal TV receiver (PTR). An embodiment of the specific components utilized to provide the functionality of media center set-top box 102 to allow time-shifted access to multiple programs at the same time is described in more detail below with reference to FIG. 2.

As mentioned previously, media center set-top box 102 includes multiple PVR engines and thus can handle multiple input media streams 108, 110, 112 and 114 (each representing a different channel). Although four media streams are shown in FIG. 1, it is understood that any number of media streams may be present.

Media streams 108, 110, 112 and 114 have several different possible input embodiments, including a television cable, a broadcast antenna, a satellite receiver, a video player, such as a tape or disk player, an audio player, such as a tape, disk or memory player, a digital device connected for example by an IEEE 1394 connection, and so forth. These inputs, after processing, selection and control (by media center set-top box 102), may be used to generate different outputs for a user. These different outputs represent the different channels the user is watching at the same time. The outputs are received by display 106.

Display 106 may be a monitor, projector, a conventional analog television receiver, or any other kind of perceivable video display. The audio portion of the output may be routed through an amplifier, such as an A/V receiver or a sound processing engine, to headphones, speakers or any other type of sound generation device. The outputs may also be sent to an external recorder, such as a VTR, PVR, CD or DVD recorder, memory card, etc.

Media center set-top box 102 may also provide connectivity to external devices through, for example, telephone port 116 and network port 118. The user interface is provided through, for example, keyboard 120 or remote control 122. Media center set-top box 102 may communicate with other devices through its own infrared port 124. Removable storage device 126 may allow for MP3 compressed audio to be stored and played later on a portable device or for camera images to be displayed on display 106.

There are many different equipment configurations for the entertainment center using media center set-top box 102 of FIG. 1 and many different possible choices of equipment to connect. A typical home entertainment system, using typical currently available equipment, might be as follows. As inputs, this typical home entertainment system might have a television antenna and either a cable television or digital broadcast satellite (DBS) input to the tuner system of the media center set-top box. A VTR or DVD recorder might be connected as an input device and an output device. A CD player and an MP3 player might be added for music. Such a system might also include a wide screen high definition television and a surround sound receiver coupled to six or eight speakers. This same system would have a small remote control for the user and offer remote control from the media center to the television, receiver, VTR and CD player. An Internet connection and keyboard would allow for web surfing, upgrades and information downloads, while a computer network would allow for file swapping and remote control from or to a personal computer in the house.

It is to be appreciated that a lesser or more equipped entertainment system than the example described above may be preferred for certain implementations. Therefore, the configuration of the entertainment system will vary from implementation to implementation depending upon numerous factors, such as price constraints, performance requirements, technological improvements, or other circumstances. Embodiments of the invention may also be applied to other types of software-driven systems that use different hardware architectures than that shown in FIGS. 1 and 2.

FIG. 2 is a more detailed diagram of an embodiment of media center set-top box 102 of FIG. 1. As shown in FIG. 2, media center set-top box 102 includes, but is not necessarily limited to, a resource manager 202, one or more tuners 204, 206, 208 and 210, one or more PVR engines 212, 214, 216 and 218, one or more circular buffers 220, 222, 224 and 226 and a playback engine 228. As described above, media center set-top box 102 includes multiple PVRs. Each PVR includes, but is not necessarily limited to, a tuner, a PVR engine and a circular buffer. Thus, in an embodiment of the present invention, the media center set-top box 102 is comprised of four PVRs, as illustrated in FIG. 2. Accordingly, the user may watch up to four channels or programs at the same time. Each of these components is described next in more detail.

As described above, multiple PVRs allow embodiments of the invention to provide time-shifted access to multiple programs at the same time. Resource manager 202 is responsible for managing the allocation of a tuner to a media stream and a circular buffer to a PVR engine as the user switches from one channel to another.

Tuners 204, 206, 208 and 210 can be any type of tuner capable of receiving one of media streams 108, 110, 112 and 114. Each tuner 204, 206, 208 and 210 is assigned one of PVR engines 212, 214, 216 and 218. A PVR engine typically is an application module that coordinates activity of its assigned tuner and circular buffer in order to provide PVR functionality. The PVR engine is responsible for trick mode functionality, such as pause, fast forward, rewind, etc. The PVR engine is also responsible for recording programs, for managing use of hard disk space, and so forth.

Each of circular buffers 220, 222, 224 and 226 is an area of memory used to store a continuous stream of data by starting again at the beginning of the buffer after reaching the end. A circular buffer is usually written by one process and read by another. Separate read and write pointers (or positions) are maintained for each of the circular buffers 220, 222, 224 and 226. The read and write pointers are not allowed to pass or overlap each other.

Circular buffers are usually used for communication between two sequential processes. One process, called the producer, places information into the circular buffer and the other, called the consumer, takes it out. In an embodiment of the invention, each of tuners 204, 206, 208 and 210 acts as the producer and playback engine 228 acts as the consumer to provide the user with time-shifted access to multiple programs at the same time. Note that the present invention is not limited to circular buffers. For example, a series of linear buffers could be used to provide similar functionality as a circular buffer.

The read and write pointers for each of circular buffers 220, 222, 224 and 226 are maintained as the user switches from one channel to another. For example, assume that the user is watching an NFL football game on a first channel represented by media stream 108 and assigned to tuner 204, PVR engine 212 and circular buffer 220. As the user is watching the first channel, PVR engine 212 is writing data at the write pointer of circular buffer 220 and playback engine 228 is reading data from the read pointer of circular buffer 220 and then displaying the data on display 106. When the user switches from the first channel to a second channel to watch a professional tennis match, PVR engine 212 continues to write data from media stream 108 to circular buffer 220 but playback engine 228 stops reading from circular buffer 220. Here, the read pointer of circular buffer 220 is stopped or stored until the user switches back to the first channel.

Assume that the second channel is represented by media stream 110 and assigned to tuner 206, PVR engine 214 and circular buffer 222. As the user is watching the second channel, PVR engine 214 is writing data at the write pointer of circular buffer 222 and playback engine 228 is reading data from the read pointer of circular buffer 222 and then displaying the data on display 106.

Assume now that the user decides to switch back to the first channel. When the user switches from the second channel to the first channel, PVR engine 214 continues to write data from media stream 110 to circular buffer 222 but playback engine 228 stops reading from circular buffer 222. The read pointer of circular buffer 222 is stopped or stored until the user switches back to the second channel.

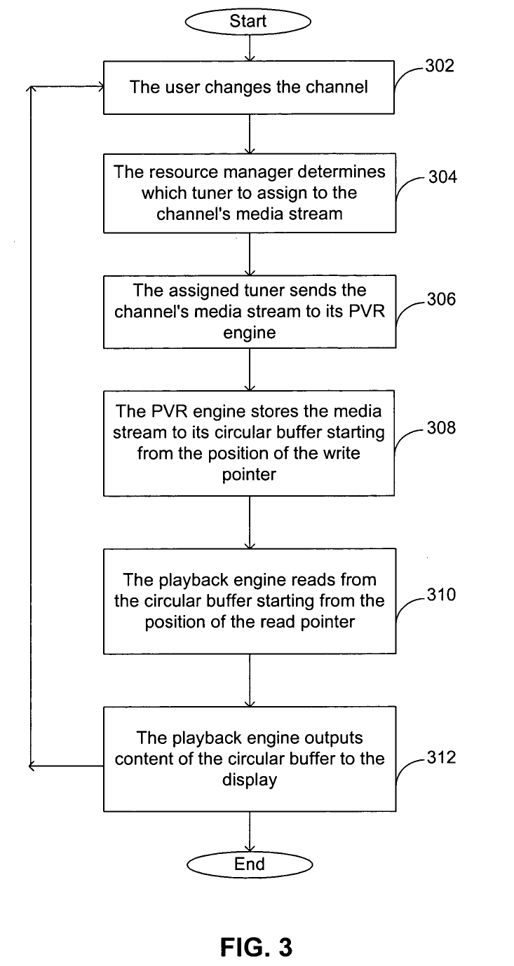

At this time, playback engine 228 proceeds again with reading data from the stored read pointer of circular buffer 220 and displaying the data on display 106. This allows the user to proceed with watching the NFL football game on the first channel from the place that he or she stopped watching the game to switch to the professional tennis match on the second channel. This allows the user to not miss any part of the NFL football game. Thus, in an embodiment of the invention, the user is given time-shifted access to both the NFL football game and the professional tennis match at the same time. Embodiments of the operation of the present invention are described next in more detail with reference to the flow diagrams of FIGS. 3-7.

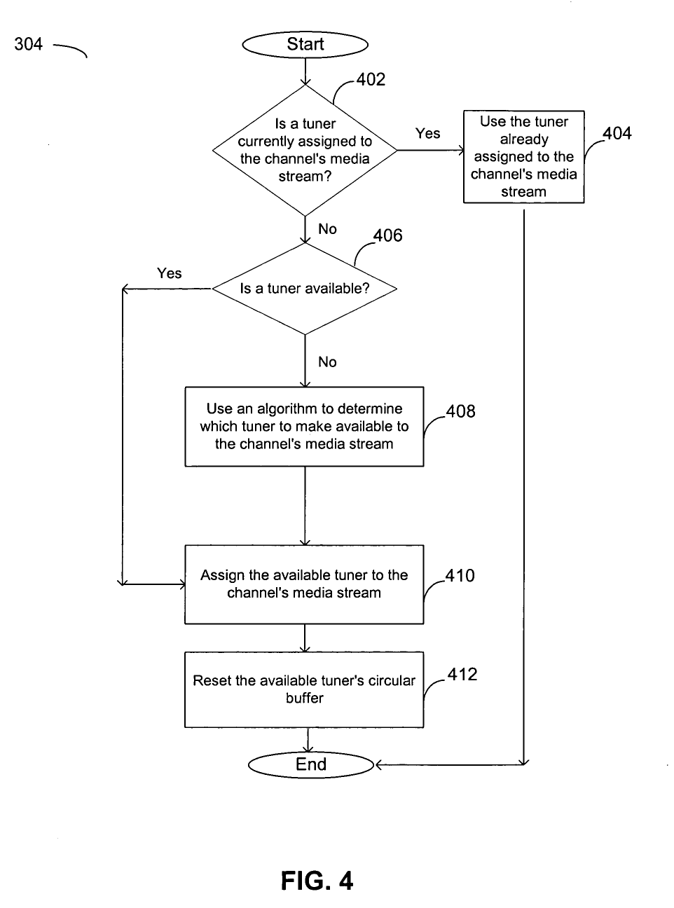

FIG. 3 is a flow diagram of one embodiment of a process for allowing a user time-shifted access to multiple programs via media center set-top box 102. Referring to FIG. 3, the process begins at processing block 302 with the user changing the channel. Once resource manager 202 determines that the user has changed to a new channel, at processing block 304, resource manager 202 determines which tuner to assign to the channel's media stream. Here, a tuner may already be assigned to the channel's media stream if the User previously tuned to this channel. If not, there may be an available tuner that resource manager 202 assigns to the channel's media stream, or in the case where there is no available tuner (all of tuners 204, 206, 208 and 210 have been assigned to a channel's media stream), resource manager 202 must take a tuner away from a channel's media stream and give the tuner to the new channel's media stream. Processing block 304 is described in more detail below with reference to FIGS. 4-6.

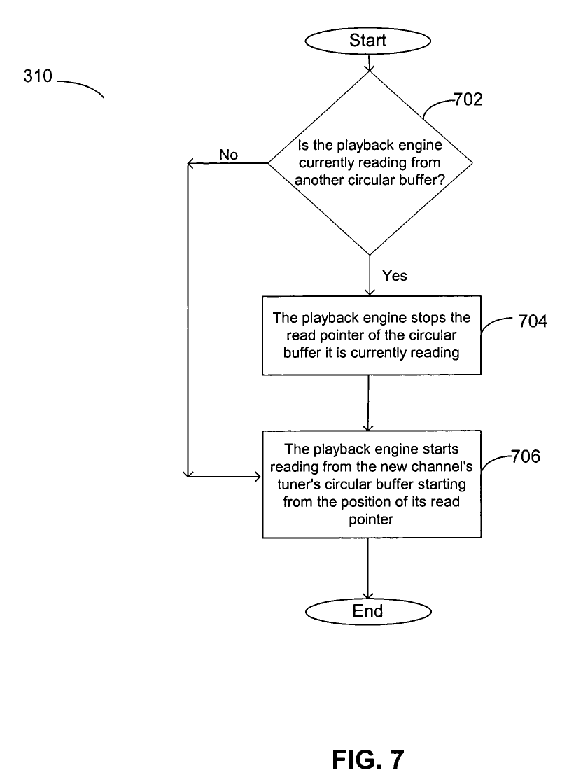

At processing block 306, the assigned tuner sends the channel's media stream to its PVR engine for processing. At processing block 308, the PVR engine stores the media stream to its circular buffer starting from the position of the write pointer. At processing block 310, playback engine 228 reads from the circular buffer starting from the position of the read pointer. Processing block 310 will be described in more detail below with reference to FIG. 7. Finally, at processing block 312, playback engine 228 outputs the content of the circular buffer to display 106. The process of FIG. 3 flows back up to processing block 302 when the user once again switches the channel.

FIG. 4 is a flow diagram of one embodiment of a process for determining which tuner to assign to a channel's media stream (processing block 304 of FIG. 3). Referring to FIG. 4, the process begins at decision block 402 where it is determined whether a tuner is currently assigned to the channel's media stream. If a tuner has already been assigned to the channel's media stream, then the process flows to processing block 404. Here, the user previously was watching the channel and has come back to the channel. Thus, the PVR engine of the previously assigned tuner has been writing data to its circular buffer while the read pointer has been stopped until the user decides to watch the channel again. Here, resource manager 202 uses the tuner that was already assigned to the channel's media stream and the process in FIG. 4 ends.

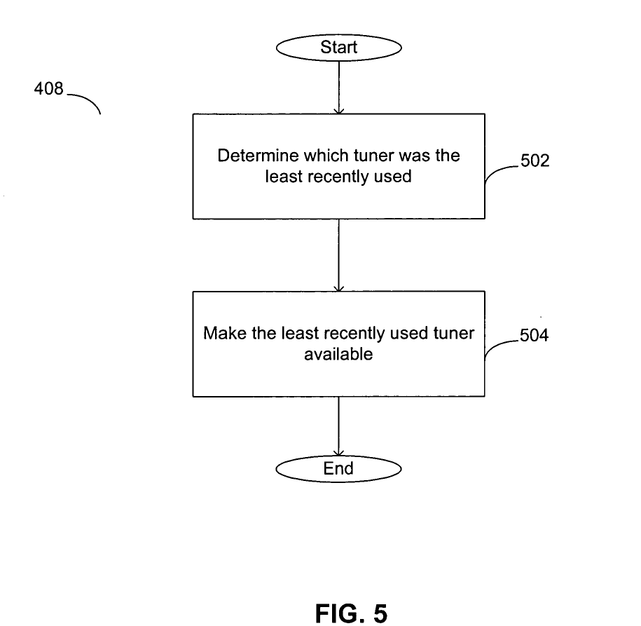

Alternatively, if at decision block 402 it is determined that a tuner has not already been assigned to the channel's media stream, then the process flows to decision block 406. At decision block 406, it is determined whether a tuner is available to assign to the channel's media stream. If so, then processing continues at processing block 410 where an available tuner is assigned to the channel's media stream. Otherwise, the processing continues at processing block 408 to make a tuner available before it can be assigned to the channel's media stream. Here, in the embodiment illustrated in FIG. 2, the user has already been watching four different channels and has now switched to a fifth different channel. Processing block 408 is described in more detail below with reference to FIG. 5 below.

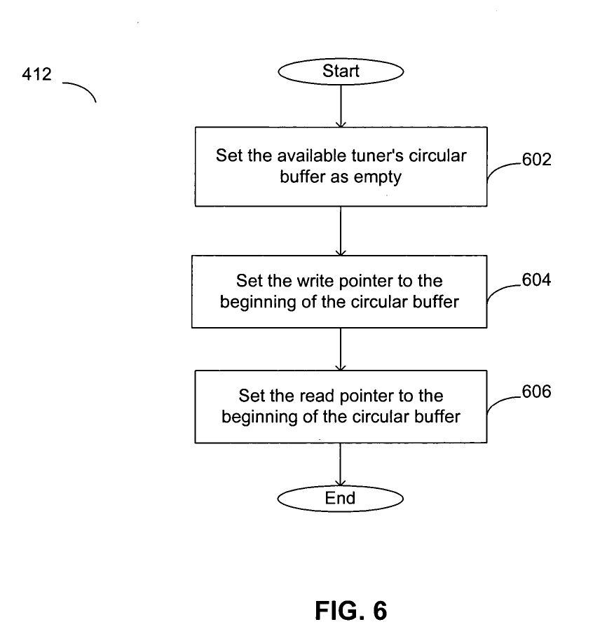

Once an available tuner has been assigned to the channel's media stream, the tuner's circular buffer is reset at processing block 412. Processing block 412 is described in more detail below with reference to FIG. 6.

FIG. 5 is a flow diagram of one embodiment of a process for using an algorithm to determine which tuner to make available to the channel's media stream (processing block 408 of FIG. 4). Referring to FIG. 5, the process begins at processing block 502 where it is determined which tuner was the least recently used (i.e., which channel did the user least recently watch). This can be determined by simply setting a timer each time the user switches from a channel. Other ways of determining which tuner to make available to the channel's media stream is contemplated by other embodiments of the invention.

At processing block 504, the least recently used tuner is made available to the channel's media stream. The process of FIG. 5 ends at this point.

FIG. 6 is a flow diagram of one embodiment of a process for resetting the available tuner's circular buffer (processing block 412 of FIG. 4). Referring to FIG. 6, the process begins at processing block 602 where the available tuner's circular buffer is set as empty. At processing block 604, the write pointer is set to the beginning of the circular buffer. Finally, at processing block 606, the read pointer is also set to the beginning of the circular buffer. The process of FIG. 6 ends at this point.

FIG. 7 is a flow diagram of one embodiment of a process for reading from the circular buffer (processing block 310 of FIG. 3). Referring to FIG. 7, the process begins at decision block 702 where it is determined whether playback engine 228 is currently reading from another circular buffer (the user was watching a channel prior to turning to the new channel). If not, then the process flows to processing block 706 where playback engine 228 starts reading from the new channel's tuner's circular buffer starting from the position of its read pointer. The process of FIG. 7 ends at this point.

If in decision block 702 it is determined that playback engine 228 is currently reading from another circular buffer (the user was watching a channel prior to turning to the new channel), the process flows to processing block 704 where playback engine 228 stops the read pointer of the circular buffer it is currently reading. The position of the read pointer is stored in the event that the user tunes back to this channel. At processing block 706, playback engine 228 starts reading from the new channel's tuner's circular buffer starting from the position of its read pointer. The process of FIG. 7 ends at this point.

A method and system for allowing time-shifted access to multiple programs at the same time via a media center set-top box have been described. It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

1. A method comprising:
receiving a request to change to a first channel;
writing a media stream of the first channel to a first buffer at a first write position;
reading the media stream of the first channel from the first buffer at a first read position;
sending the read media stream of the first channel to a display; and
upon receiving a request to change to a second channel, discontinuing the reading of the media stream of the first channel at the first read position while continuing to write the media stream of the first channel at the first write position.

2. The method of claim 1, further comprising:
writing a media stream of the second channel to a second buffer at a second write position;
reading the media stream of the second channel from the second buffer at a second read position; and
sending the read media stream of the second channel to the display.

3. The method of claim 2, further comprising:
upon receiving a request to change back to the first channel, discontinuing the reading of the media stream of the second channel at the second read position while continuing to write the media stream of the second channel at the second write position;
continue reading the media stream of the first channel at the first read position; and
sending the read media stream of the first channel to the display.

4. The method of claim 2, further comprising:
ensuring that the first read and write positions do not overlap; and
ensuring that the second read and write positions do not overlap.

5. The method of claim 1, further comprising:
upon receiving the request to change to the first channel, determining an available tuner to assign to the media stream of the first channel; and
upon receiving the request to change to the second channel, determining an available tuner to assign to the media stream of the second channel, wherein the tuner assigned to the media stream of the first channel is different from the tuner assigned to the media stream of the second channel.

6. The method of claim 5, further comprising:
receiving a request to change to a third channel; and
making a tuner available to assign to a media stream of the third channel.

7. The method of claim 6, wherein a tuner is made available by assigning one of: the first tuner to the media stream of the third channel if the first channel was watched less recently by a user than the second channel and the second tuner to the media stream of the third channel if the second channel was watched less recently by the user than the first channel.

8. The method of claim 2, wherein the first buffer is a circular buffer and the second buffer is a circular buffer.

9. A system comprising:
a resource manager that receives a request to change to a first channel;
a first personal video recorder (PVR) engine that writes a media stream of the first channel to a first buffer at a first write position; and
a playback engine that reads the media stream of the first channel from the first buffer at a first read position, wherein the playback engine then sends the read media stream of the first channel to a display, and wherein the playback engine discontinues the reading of the media stream of the first channel at the first read position once the resource manager receives a request to change to a second channel while the first PVR engine continues to write the media stream of the first channel at the first write position.

10. The system of claim 9, further comprising:
a second PVR engine that writes a media stream of the second channel to a second buffer at a second write position, wherein the playback engine then reads the media stream of the second channel from the second buffer at a second read position, and wherein the playback engine then sends the read media stream of the second channel to the display.

11. The system of claim 10, wherein the playback engine discontinues the reading of the media stream of the second channel at the second read position once the resource manager receives a request to change back to the first channel while the second PVR engine continues to write the media stream of the second channel at the second write position, wherein the playback engine continues reading the media steam of the first channel at the first read position, and wherein the playback engine sends the read media stream of the first channel to the display.

12. The system of claim 10, wherein the resource manager ensures that the first read and write positions do not overlap, and wherein the resource manager ensures that the second read and write positions do not overlap.

13. The system of claim 9, wherein the resource manager determines an available tuner to assign to the media stream of the first channel upon receiving the request to change to the first channel, wherein the recource manager determines an available tuner to assign to the media stream of the second channel upon receiving the request to change to the second channel, and wherein the tuner assigned to the media stream of the first channel is different from the tuner assigned to the media stream of the second channel.

14. The system of claim 13, wherein the resource manager receives a request to change to a third channel, and wherein the resource manager makes a tuner available to assign to a media stream of the third channel.

15. The system of claim 14, wherein a tuner is made available by assigning one of: the first tuner to the media stream of the third channel if the first channel was watched less recently by a user than the second channel and the second tuner to the media stream of the third channel if the second channel was watched less recently by the user than the first channel.

16. The system of claim 10, wherein the first buffer is a circular buffer and the second buffer is a circular buffer.

17. A machine-readable medium containing instructions which, when executed by a processing system, cause the processing system to perform a method, the method comprising:
receiving a request to change to a first channel;
writing a media stream of the first channel to a first buffer at a first write position;
reading the media stream of the first channel from the first buffer at a first read position;
sending the read media stream of the first channel to a display; and
upon receiving a request to change to a second channel, discontinue the reading of the media stream of the first channel at the first read position while continuing to write the media stream of the first channel at the first write position.

18. The machine-readable medium of claim 17, further comprising:
writing a media stream of the second channel to a second buffer at a second write position;
reading the media stream of the second channel from the second buffer at a second read position; and
sending the read media stream of the second channel to the display.

19. The machine-readable medium of claim 18, further comprising:
upon receiving a request to change back to the first channel, discontinue the reading of the media stream of the second channel at the second read position while continuing to write the media stream of the second channel at the second write position;
continue reading the media stream of the first channel at the first read position; and
sending the read media stream of the first channel to the display.

20. The machine-readable medium of claim 18, further comprising:
ensuring that the first read and write positions do not overlap; and
ensuring that the second read and write positions do not overlap.

21. The machine-readable medium of claim 17, further comprising:
upon receiving the request to change to the first channel, determining an available tuner to assign to the media stream of the first channel; and
upon receiving the request to change to the second channel, determining an available tuner to assign to the media stream of the second channel, wherein the tuner assigned to the media stream of the first channel is different from the tuner assigned to the media stream of the second channel.

22. The machine-readable medium of claim 21, further comprising:
receiving a request to change to a third channel; and
making a tuner available to assign to a media stream of the third channel.

23. The machine-readable medium of claim 22, wherein a tuner is made available by assigning one of: the first tuner to the media stream of the third channel if the first channel was watched less recently by a user than the second channel and the second tuner to the media stream of the third channel if the second channel was watched less recently by the user than the first channel.

24. The machine-readable medium of claim 18, wherein the first buffer is a circular buffer and the second buffer is a circular buffer.
